(19) United States
(12) Patent Application Publication
(10) Pub. No.: US 2020/0336302 A1
(43) Pub. Date: Oct. 22, 2020

(54) System and Method for Secure Causality Discovery

(71) Applicant: Inpher, Inc., New York, NY (US)

(72) Inventors: Dimitar Petkov Jetchev, St-Saphorin-Lavaux (CH); Peter Cotton, Darien, CT (US)

(21) Appl. No.: 16/853,719

(22) Filed: Apr. 20, 2020

Related U.S. Application Data
(60) Provisional application No. 62/836,337, filed on Apr. 19, 2019.

(51) Int. Cl. H04L 9/08; G06N 5/02

(52) U.S. Cl. CPC H04L 9/085; H04L 2209/46; G06N 5/02

(57) ABSTRACT

A method is performed by a plurality of networked party computing systems configured to perform secure multi-party computations, each computer system having at least one processor and a memory. The method can include creating a secret shared matrix based on secret data of each of the plurality of party computing systems, wherein the secret shared matrix includes a plurality of time-shifted sequences of data from each of an independent time series of data and a dependent time series of data; computing, based on the secret shared matrix and in a secure multi-party computation, a secret shared model for predicting the dependent time series of data based on the independent time series of data; and using the secret shared model to determine a statistic for one of the plurality of time-shifted sequences of data from the independent time series as a predictor of the dependent time series of data.

### RELATED APPLICATIONS

The subject matter of this application is related to U.S. Provisional Application No. 62/836,337, filed on 2019 Apr. 19, which is hereby incorporated by reference in its entirety.

### SUMMARY OF THE INVENTION

This disclosure relates generally to predictive modeling, and more particularly to a system and method for discovering relationships between privately held data.

In accordance with one embodiment, a method is performed by a plurality of networked party computing systems configured to perform secure multi-party computations, each computer system having at least one processor and a memory. The method includes creating a secret shared matrix based on secret data of each of the plurality of party computing systems, wherein the secret shared matrix includes a plurality of time-shifted sequences of data from each of an independent time series of data and a dependent time series of data; computing, based on the secret shared matrix and in a secure multi-party computation, a secret shared model for predicting the dependent time series of data based on the independent time series of data; and using the secret shared model to determine a statistic for one of the plurality of time-shifted sequences of data from the independent time series as a predictor of the dependent time series of data.

The method can be performed such that a first of the plurality of party computing systems secret shares the independent time series of data with others of the plurality of party computing systems.

The method can be performed such that a second of the plurality of party computing systems secret shares the dependent time series of data with others of the plurality of party computing systems.

The method can be performed such that each of a first and a second of the plurality of party computing systems secret shares a portion of the independent time series of data with others of the plurality of party computing systems.

The method can be performed such that a third of the plurality of party computing systems secret shares the dependent time series of data with others of the plurality of party computing systems.

The method can be performed such that the statistic is a Student's test statistic (t-statistic).

The method can be performed such that the statistic is a probability value (p-value).

The method can be performed such that the statistic is predictive of Granger causality.

A non-transitory computer readable medium can be encoded with instruction, wherein the instructions, when executed by the plurality of networked party computing systems, cause the plurality of networked party computing systems to perform any of the foregoing methods.

### BRIEF DESCRIPTION OF THE DRAWINGS

FIG. 1 illustrates a general computer architecture in accordance with which embodiments can be practiced.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted. By way of example, this disclosure may set out a set or list of a number of options or possibilities for an embodiment, and in such case, this disclosure specifically contemplates all clearly feasible combinations and/or permutations of items in the set or list.

### Introduction

Under a plethora of labels that include Machine Learning, Data Science and Artificial Intelligence, applied statistical modeling has taken on new significance in the 21st Century. It might well be said that we live in a prediction economy as our myriad movements, such as our locations and decisions in physical or commercial worlds, are either ostensibly predicted or indirectly forecast inside engines for recommendation, identification, pricing or navigation. Millions of predictions drive real-time micro-decision making and with it most of modern commerce. We assert that indirectly and in disguise, micro-predictions are bought and sold in one way or another like any other good.

Observers of industry have estimated that superior prediction may result in double digit productivity gains across a slew of industries. Enormous effort and time goes into the creation of accurate predictive models. This is not new activity. For decades hedge funds have survived or failed based on their ability to make accurate predictions on short and long time scales—with the former category of predictions constituting an example of a stream of predictions whose accuracy, over time, may be revealed by statistical methods.

In recent times sizable investments have been made by buy-side firms in predictive technology including models that incorporate new sources of data. There are approximately four hundred companies that collect and sell alternative data to hedge funds, for example, over and above the existing enterprise data industry. Funds attempt to obtain a small edge in prediction over their peers and face an increasingly difficult search in the space of data and models.

Conversely, firms that collect and sell data for predictive uses face a quandary: how can they demonstrate the value of their data for a particular predictive purpose (usually not revealed to them) without giving up their data in advance? Sometimes it is possible to provide data in a trial, but the value of the data might lie in part in its historical record. Conversely the firm that might benefit from a new data source may be reluctant to reveal the intended use, and certainly not the model in which the data is used.

### Overview

The disclosed system and method can be used to provide consumers of data and sellers of data a way to discover a potentially mutually beneficial outcome without the risk of revelation of commercially sensitive intent or commercially valuable data. In one embodiment, Party A, who wishes to look for ways to improve their predictive model, prepares a time series of model errors (residuals). Party B prepares a plurality of time series of data that may or may not be causally related to the model residuals. Then, through a complex communication protocol that is described herein, statistical measures relating the data to model residuals are computed and, in a preferred embodiment, relayed to Party A only.

In one embodiment, Party A never reveals any information about their model, or model residuals, to anyone. Party A has a free look and might, at their discretion, choose to take further action. Party B need not reveal their data to anyone. Only a small number of statistical numbers (if need be a single number) is revealed to Party A. This is commercially more appealing than revealing a large number of data points as part of a trial data agreement.

Use Case

Over the counter trading, for example, can benefit from superior prediction and data discovery. An example of a repeated prediction that might typically be required is the estimation of the probability that a dealer, in responding to a client inquiry with a suggested price, will win the trade. In this example, a model is created by in-house quantitative developers that provides an estimate pₖ that the trade will be filled. The actual outcome, yₖ is 0 or 1. The evaluation of the model might comprise a mean square error quantity given by:

$$\frac{1}{N} \sqrt{{\sum }_{k = 1}^{N} {( {p}_{k} - {y}_{k} )}^{2}}$$

The modeler (Party A) is, in this example, attempting to minimize the squared error between pₖ and the actual outcome. This difference, called the error or residual, is εₖ:=pₖ−yₖ Party A, having performed their job to the best of their ability and used all relevant data at their immediate disposal, has generated a sequence of numbers {εₖ} and might be given to believing that this sequence is uncorrelated with (so far as she is aware), any other time series. However, unbeknownst to Party A, another Party B may own a time series of data {x₁, . . . , xₖ, . . . , x_{N}} that helps predict εₖ In the presence of a trusted third Party C, Party A and Party B might supply their data to Party C, and Party C might perform a statistical test such as the one described in the next section.

In theory, Party C can broker a relationship between Party A and Party B. However, in practice the commercial significance of the modeling task, the desire for secrecy, and the risk of premature disclosure can limit this operating model. Exemplary embodiments of the present invention can obviate the need for a trusted third Party C, as will become clear.

Granger Causality

The Granger causality test is a well-known statistical hypothesis test that allows for determining whether one time series is useful for predicting another one. A time series x={xₜ} is said to Granger cause another time series y={yₜ} if one can show via a sequence of t-tests and F-tests on time-lagged values of x that these values provide statistically significant information on the future values of y.

More concretely, consider x={xₜ} (independent time series) and y={yₜ} (dependent time series). One is trying to predict yₜ in terms of the time-lagged time series y_{t-δ} (which represents the time series y time shifted by a lag δ) and x_{t-δ}, (which represents the time series x time shifted by a lag δ′) for various values of the lags δ and δ′.

To test which of the lagged/shifted series xₜ₋₈, will be statistically significant for predicting yₜ, we build a linear regression modelyₜ˜β₁yₜ₋₁+ . . . +βₘyₜ₋ₘ+γ₁xₜ₋₁+ . . . +γₙxₜ₋ₙ In the explanation below, the notation yⱼ will be used to denote the shifted time series y_{t-δ} for the jth lag δ. The notation xⱼ will be used to denote the shifted time series x_{t-δ}, for the jth lag δ′. Given j=1, . . . , n, we consider the null hypothesis: γⱼ=0 for each j in order to determine whether the time series xⱼ Granger causes any of the time series yₜ.

In order to test the null hypothesis, we use statistics based on the t-distribution: if \hat{β}ᵢ and \hat{γ}ⱼ are the estimated coefficients (using some training data set for the above linear regression model), the test statistics are then defined as:

$${t}_{j} = \frac{{\hat{γ}}_{j}}{se ( {\hat{γ}}_{j} )} ,$$

where se(\hat{γ}ⱼ) is the standard error defined asse

$$( {\hat{γ}}_{j} ) = \frac{RSS}{\sqrt{n - k} \cdot stdev ( {x}_{j} )} .$$

Here, RSS=Σₛ₌₁^{N}(yₛ−ŷₛ)₂
is the residual sum of squares and k is the total number of features used in the regression model (basically, k=n+m above). The p-value of the coefficient βᵢ is then equal to 1−Φ(tᵢ) where Φ is the cumulative distribution function for the Gaussian distribution N(0,1).

Another useful statistic for the above setting is the R² (coefficient of determination). The R² is a measure for what percentage of the variation in the dependent variable is explained by the independent variable. The coefficient of determination R² is then defined as

$${R}^{2} = 1 - \frac{RSS}{SS}$$

where SS=Σₛ₌₁^{N}(yₛ−y̅)² is the total sum of squares.

A method as follows can be used in a multi-party computation context to create a model that can be used to determine whether a particular time shifted series x Granger causes γ. The computation is performed in privacy preserving manner where x, y and/or portions thereof come from distinct secret data sources, and these data are retained as secret by their sources.

We create a matrix X consisting of columns x₁, x₂, . . . , xₙ with each column being a vector representing a time shifted version of the time series x. We next create the augmented matrix X′ by prepending the columns of X with columns y₁, y₂, . . . , yₘ where each of the prepended columns is a vector representing a time shifted version of the time series y. One or all of the matrices X, X′ and the time series y are created as secret shared data among multiple parties or computing systems. For example, we can mask the values of X′ with a precomputed random orthogonal matrix Q by computing the matrix Z=X′Q via Beaver multiplication. We can then compute and reveal Z^{T}Z. We can then compute Z^{T} y via a Beaver multiplication and use that to compute the model (in secret shares) as: θ=Q(Z^{T} Z)⁻¹Z^{T} y

We can then use this secret shared model to compute residuals without exposing the model itself. Using the secret shared model, we can compute and reveal the residual sum of squares RSS and the variances var(xᵢ) for every i. We can then compute stdev(xᵢ) and the t-statistic tᵢ for each i to identify whether any particular time shifted series x Granger causes y.

Additional Use Cases

The present invention is applicable and extendable to numerous applications in finance. Commodities trading benefits from superior estimation of fundamental supply and demand quantities, transport timing, meteorological forecasts, satellite data and many sources of data that are hard to enumerate. Model governance operations inside banks benefit from superior ongoing performance analysis of models.

Efforts to create clean data benefit because algorithms used to estimate the likelihood of data errors can be enhanced by exemplary embodiments of the invention (in this case, the exogenous data sources might include other versions of the same data that have different patterns of errors). The enhancement of enterprise data can fall under this rubric.

The likelihood that a particular transaction is fraudulent provides another example of a model whose efficacy could be evaluated—leading to improvements. Fraud is a huge problem for the financial industry and takes on many forms. Other operational problems include reconciliation. Models that predict the likelihood of a name match can be enhanced in precisely the same manner. Custody services offered by banks can be enhanced. For example a model that predicts the likelihood of a trade generating a good outcome for a client can be improved—this model may take into account factors which are not purely “alpha” (return based) but also take into account client needs and risk profile.

Research recommendation harvesting is another area where the present invention may be applied. The probability that an analyst's recommendation will pan out is worthy of careful modeling, and such a model can be improved as above.

The secure causality discovery method discussed above may be implemented as a system using one or more computing devices, such as servers, databases, and personal computing devices. The system may also include one or more networks that connect the various computing devices. The networks may comprise, for example, any one or more of the Internet, an intranet, a Local Area Network (LAN), a Wide Area Network (WAN), an Ethernet connection, a WiFi network, a Global System for Mobile Communication (GSM) link, a cellular phone network, a Global Positioning System (GPS) link, a satellite communications network, or other network, for example. Personal computing devices such as desktop computers, laptop computers, tablet computers and mobile phones may be used by users and system administrators to access and control the system.

Various types and configurations of networks, servers, databases and personal computing devices may be used with exemplary embodiments of the invention, and that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example.

Data and information maintained by the servers and computing devices may be stored and cataloged in one or more databases, which may comprise or interface with a searchable database and/or a cloud database. Other databases, such as a query format database, a Standard Query Language (SQL) format database, a storage area network (SAN), or another similar data storage device, query format, platform or resource may be used.

As described above, the method and system may include a number of servers and personal computing devices or computers, each of which may include at least one programmed processor and at least one memory or storage device. The memory may store a set of instructions. The instructions may be either permanently or temporarily stored in the memory or memories of the processors. The set of instructions for performing a particular task may be characterized as a program, software program, software application, app, or software. The modules described above may comprise software, firmware, hardware, or a combination of the foregoing. The servers and personal computing devices may include software or computer programs stored in the memory (e.g., non-transitory computer readable medium containing program code instructions executed by the processor) for executing the methods described herein.

Computer Implementation

Components of the embodiments disclosed herein, which may be referred to as methods, processes, applications, programs, modules, engines, functions or the like, can be implemented by configuring one or more computers or computer systems using special purpose software embodied as instructions on a non-transitory computer readable medium. The one or more computers or computer systems can be or include one or more standalone, client and/or server computers, which can be optionally networked through wired and/or wireless networks as a networked computer system.

The special purpose software can include one or more instances thereof, each of which can include, for example, one or more of client software, server software, desktop application software, app software, database software, operating system software, and driver software. Client software can be configured to operate a system as a client that sends requests for and receives information from one or more servers and/or databases. Server software can be configured to operate a system as one or more servers that receive requests for and send information to one or more clients. Desktop application software and/or app software can operate a desktop application or app on desktop and/or portable computers. Database software can be configured to operate one or more databases on a system to store data and/or information and respond to requests by client software to retrieve, store, and/or update data. Operating system software and driver software can be configured to provide an operating system as a platform and/or drivers as interfaces to hardware or processes for use by other software of a computer or computer system. By way of example, any data created, used or operated upon by the embodiments disclosed herein can be stored in, accessed from, and/or modified in a database operating on a computer system.

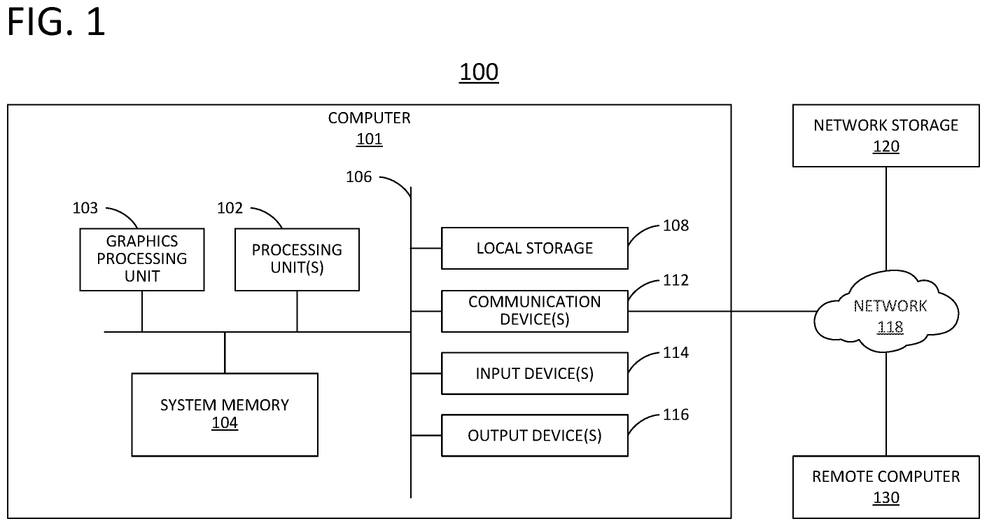

FIG. 1 illustrates a general computer architecture 100 that can be appropriately configured to implement components disclosed in accordance with various embodiments. The computing architecture 100 can include various common computing elements, such as a computer 101, a network 118, and one or more remote computers 130. The embodiments disclosed herein, however, are not limited to implementation by the general computing architecture 100.

Referring to FIG. 1, the computer 101 can be any of a variety of general purpose computers such as, for example, a server, a desktop computer, a laptop computer, a tablet computer or a mobile computing device. The computer 101 can include a processing unit 102, a system memory 104 and a system bus 106.

The processing unit 102 can be or include one or more of any of various commercially available computer processors, which can each include one or more processing cores that can operate independently of each other. Additional co-processing units, such as a graphics processing unit 103, also can be present in the computer.

The system memory 104 can include volatile devices, such as dynamic random access memory (DRAM) or other random access memory devices. The system memory 104 can also or alternatively include non-volatile devices, such as a read-only memory or flash memory.

The computer 101 can include local non-volatile secondary storage 108 such as a disk drive, solid state disk, or removable memory card. The local storage 108 can include one or more removable and/or non-removable storage units. The local storage 108 can be used to store an operating system that initiates and manages various applications that execute on the computer. The local storage 108 can also be used to store special purpose software configured to implement the components of the embodiments disclosed herein and that can be executed as one or more applications under the operating system.

The computer 101 can also include communication device(s) 112 through which the computer communicates with other devices, such as one or more remote computers 130, over wired and/or wireless computer networks 118. Communications device(s) 112 can include, for example, a network interface for communicating data over a wired computer network. The communication device(s) 112 can include, for example, one or more radio transmitters for communications over Wi-Fi, Bluetooth, and/or mobile telephone networks.

The computer 101 can also access network storage 120 through the computer network 118. The network storage can include, for example, a network attached storage device located on a local network, or cloud-based storage hosted at one or more remote data centers. The operating system and/or special purpose software can alternatively be stored in the network storage 120.

The computer 101 can have various input device(s) 114 such as a keyboard, mouse, touchscreen, camera, microphone, accelerometer, thermometer, magnetometer, or any other sensor. Output device(s) 116 such as a display, speakers, printer, or eccentric rotating mass vibration motor can also be included.

The various storage 108, communication device(s) 112, output devices 116 and input devices 114 can be integrated within a housing of the computer, or can be connected through various input/output interface devices on the computer, in which case the reference numbers 108, 112, 114 and 116 can indicate either the interface for connection to a device or the device itself as the case may be.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs can be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs).

### CONCLUDING COMMENTS

Although the subject matter has been described in terms of certain embodiments, other embodiments that may or may not provide various features and aspects set forth herein shall be understood to be contemplated by this disclosure. The specific embodiments described above are disclosed as examples only, and the scope of the patented subject matter is defined by the claims that follow. In the claims, the term “based upon” shall include situations in which a factor is taken into account directly and/or indirectly, and possibly in conjunction with other factors, in producing a result or effect. In the claims, a portion shall include greater than none and up to the whole of a thing; encryption of a thing shall include encryption of a portion of the thing. In method claims, any reference characters are used for convenience of description only, and do not indicate a particular order for performing a method.

1. A method performed by a plurality of networked party computing systems configured to perform secure multi-party computations, each computer system having at least one processor and a memory, the method comprising:
creating a secret shared matrix based on secret data of each of the plurality of party computing systems, wherein the secret shared matrix comprises a plurality of time-shifted sequences of data from each of an independent time series of data and a dependent time series of data;
computing, based on the secret shared matrix and in a secure multi-party computation, a secret shared model for predicting the dependent time series of data based on the independent time series of data; and
using the secret shared model to determine a statistic for one of the plurality of time-shifted sequences of data from the independent time series as a predictor of the dependent time series of data.

2. The method of claim 1, wherein a first of the plurality of party computing systems secret shares the independent time series of data with others of the plurality of party computing systems.

3. The method of claim 2, wherein a second of the plurality of party computing systems secret shares the dependent time series of data with others of the plurality of party computing systems.

4. The method of claim 1, wherein each of a first and a second of the plurality of party computing systems secret shares a portion of the independent time series of data with others of the plurality of party computing systems.

5. The method of claim 4, wherein a third of the plurality of party computing systems secret shares the dependent time series of data with others of the plurality of party computing systems.

6. The method of claim 1, wherein the statistic is a Student's test statistic (t-statistic).

7. The method of claim 1, wherein the statistic is a probability value (p-value).

8. The method of claim 1, wherein the statistic is predictive of Granger causality.

9. The plurality of networked party computing systems configured to perform the method of claim 1.

10. A non-transitory computer readable medium having instruction stored thereon, wherein the instructions, when executed by the plurality of networked party computing systems, cause the plurality of networked party computing systems to perform the method of claim 1.
